(19) United States
(12) Patent Application Publication
(10) Pub. No.: US 2017/0085423 A1
(43) Pub. Date: Mar. 23, 2017

(54) PROFILE MODIFICATION METHOD, AND ASSOCIATED DEVICE AND MICROCIRCUIT

(71) Applicant: OBERTHUR TECHNOLOGIES, Colombes (FR)

(72) Inventors: Tomasz WOZNIAK, Colombes (FR); Jerome DUMOULIN, Colombes (FR); Alexis MICHEL, Colombes (FR); Arnaud DANREE, Colombes (FR)

(73) Assignee: OBERTHUR TECHNOLOGIES, Colombes (FR)

(21) Appl. No.: 15/310,932

(22) PCT Filed: May 18, 2015
(86) PCT No.: PCT/FR2015/051285

§ 371 Date: Nov. 14, 2016

(30) Foreign Application Priority Data
May 19, 2014 (FR) 1454468

(51) Int. Cl. H04L 12/24; H04M 3/51; H04L 29/08

(52) U.S. Cl. CPC H04L 41/0813; H04L 67/306; H04M 3/5116; H04M 2242/04

(57) ABSTRACT

A method for modifying the profile in a device (D) including a communication module for communicating on a communication network, the device (D) being provided with a microcircuit storing connection data used by the communication module and associated with a profile, the method including the following steps: reception, by the microcircuit and via the communication module, of a request to deactivate (E6) the profile; transmission, by the microcircuit, of a first message (E10) to the device; transmission, by the device and to the microcircuit, of a response (E14) indicative of the existence of a critical situation; following the receipt of the response (E14) by the microcircuit, implementation of a time delay mechanism (E18); upon expiry of the time delay (E18), transmission, by the microcircuit and to the device, of a second message (E22) resulting in the deactivation of the profile. An associated device and microcircuit are also described.

### TECHNICAL FIELD TO WHICH THE INVENTION RELATES

The present invention relates to communications on a telecommunication network using connection data associated with a profile.

More particularly, it relates to a method for modifying a profile.

The invention can be applied particularly advantageously in the case where a critical situation, such as an emergency situation initiated by an emergency call, is in progress when the profile modification (for example a profile change) is requested.

### TECHNOLOGICAL BACKGROUND

Patent application US 2013/165 073 describes a profile modification method in a device comprising a communication module in a communication network. The device is, notably, provided with a microcircuit card which stores first and second connection data for connection to the telecommunication network, associated with a first and a second profile respectively.

There are also known devices designed to transmit an emergency call, initiated manually or automatically, to an emergency call center, as described for example in the document US 2009/253 403.

### OBJECT OF THE INVENTION

In this context, the present invention proposes a profile modification method as outlined above, comprising the following steps:
reception, by the microcircuit and via the communication module, of a request to deactivate the profile;
transmission by the microcircuit of a first message to the device;
transmission, by the device to the microcircuit, of a response indicative of the presence of a critical situation;
following the receipt of said response by the microcircuit, implementation of a time delay mechanism;
on expiry of the time delay, transmission, by the microcircuit to the device, of a second message causing the deactivation of the profile.

The deactivation of the profile is therefore performed after a time interval determined by the time delay.

During this time interval (which is usually at least equal to the duration of the critical situation), the profile is therefore always active, and, in the case of an emergency situation, the emergency call center can, for example, always transmit a call to the device; this is because the device is identified at the emergency center by the connection data (associated with the profile, for example a telephone number), since the emergency call has been made with this profile.

Furthermore, since the critical situation has disappeared at the moment of deactivation of the profile, this deactivation will not be problematic.

The connection data are, for example, first connection data, and the profile is, for example, a first profile. In this case, the profile modification may be a profile change. The deactivation of the (first) profile corresponds, in this case, to the activation of the second profile.

It should be noted that, in this case in particular, the time delay causes the second message, for the activation of the second profile, to be queued. This prevents, notably, any needless attempts to activate the profile, which would add to the number of exchanges between the device and the microcircuit whereas the aim is to benefit fully from the capacity of these elements throughout the critical situation (such as an emergency situation).

In a variant, the profile modification may be an updating of the profile or a deletion of the profile (including any necessary erasure of the connection data associated with the profile).

As mentioned above, the critical situation is, for example, an emergency situation, such as an emergency situation initiated by a call from the device (using its communication module) to an emergency center. In a variant, it may be a situation in which it is desired to reduce the power consumption of the device, for example when the device is provided with electrical energy storage means (a battery, for example) and the amount of electrical energy stored is below a threshold.

Provision may be made for the response indicative of the presence of a critical situation to contain a data element representative of a remaining duration of the critical situation, this remaining duration (expressed as a number of seconds, for example) being determined, for example, by the device. According to a feasible embodiment, this remaining duration is determined by the difference between the transmission of the emergency call by the device and the reception of the first message by the device.

According to a first embodiment, the first message is a proactive command resulting in interrogation about the presence of a critical situation.

In this case, since the microcircuit verifies the presence or absence of a critical situation in advance, it does not execute a step of preparing for the profile modification immediately, but only after the expiry of the time delay.

According to a second embodiment, the first message is a request to update the microcircuit information used by the device, for example a “REFRESH” command as defined by the ETSI TS 102 223 technical specification.

In this case, provision may be made for a profile modification preparation step to be executed by the microcircuit on receipt of the request for deactivation of the (first) profile, the microcircuit having no knowledge of the presence of the critical situation at this moment. The response indicative of the presence of a critical situation may then be a message rejecting the update request, for example a FETCH or TERMINAL RESPONSE message defined in the ETSI TS 102 223 technical specification and indicative of the rejection of the update request.

Provision may be made for the method to further comprise a step of transmission, by the microcircuit to an operating server of the communication network, of a message of notification of the critical situation, this notification message comprising, if necessary, a data element representative of said remaining duration. The operating server of the communication network is, for example, the entity that has previously transmitted the request for deactivation of the aforementioned profile.

According to a first possibility (compatible with both the first and the second embodiment), the time delay mechanism is a counter triggered by the operating server of the communication network on receipt of the notification message. This counter is, for example, initialized to the value represented by the data element included in the notification message.

In this case, provision is made, for example, for a message (such as a RETRY command as explained below) for deactivation of the (first) profile (for example a message for activation of the second profile) to be transmitted from the operating server of the telecommunication network to the microcircuit on expiry of the counter.

According to a second possibility (compatible with both the first and the second embodiment), the time delay mechanism is a counter triggered by the microcircuit on receipt of the response indicative of the presence of a critical situation. This counter is, for example, initialized to the value represented by the data element included in the response indicative of the presence of a critical situation.

As mentioned above, the method may comprise a preliminary step of transmission by the device of an emergency call on the communication network, using the (first) connection data associated with the (first) profile. In the embodiments described, this emergency call initiates the emergency situation.

The communication network is, for example, a mobile telephone network, as in the example described below. In a variant, it may be a wired network, using the power line carrier current (PLC) method, for example.

The invention also proposes a device comprising a communication module for communicating on a communication network and provided with a microcircuit storing connection data used by the communication module and associated with a profile, characterized in that it comprises means for the reception, by the microcircuit and via the communication module, of a request for deactivation; means for the transmission, by the microcircuit, of a first message to the device; means for the transmission, by the device to the microcircuit, of a response indicative of the presence of a critical situation; means designed to implement, following the receipt of said response by the microcircuit, a time delay mechanism; and means for the transmission, by the microcircuit to the device on expiry of the time delay, of a second message causing the deactivation of the profile.

Finally, the invention proposes a microcircuit intended to be fitted to a device comprising a communication module for communicating on a communication network, the microcircuit storing connection data used by the communication module and associated with a profile, characterized in that it comprises means for the reception, via the communication module, of a request for deactivation of the profile; means for the transmission of a first message to the device; means for reception of a response indicative of the presence of a critical situation; means designed to implement, following the receipt of said response, a time delay mechanism; and means for the transmission to the device, on expiry of the time delay, of a second message causing the deactivation of the profile.

This device and this microcircuit may also include at least some of the optional characteristics described above in terms of method.

### DETAILED DESCRIPTION OF AN EXEMPLARY EMBODIMENT

The following description, referring to the attached drawings which are provided by way of non-limiting example, will make the nature and application of the invention clear.

In the attached drawings:

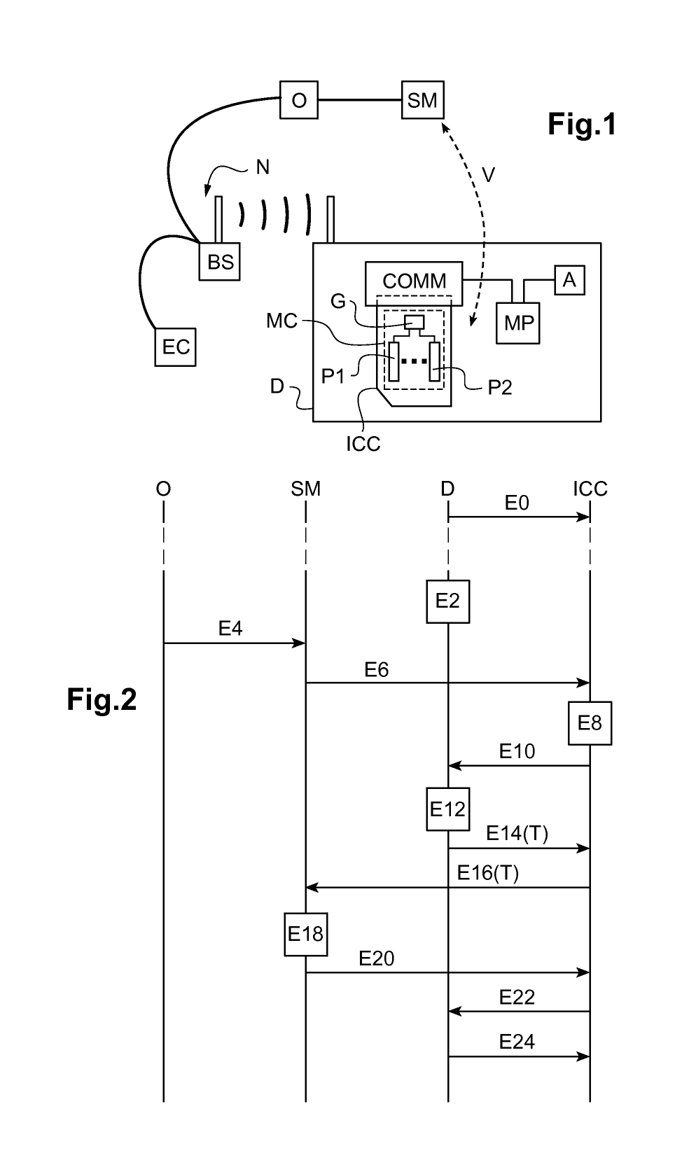

FIG. 1 shows the main elements of a system in which the present invention can be used;

FIG. 2 shows a first example of a method for a profile change requested in an emergency situation, according to the teachings of the invention;

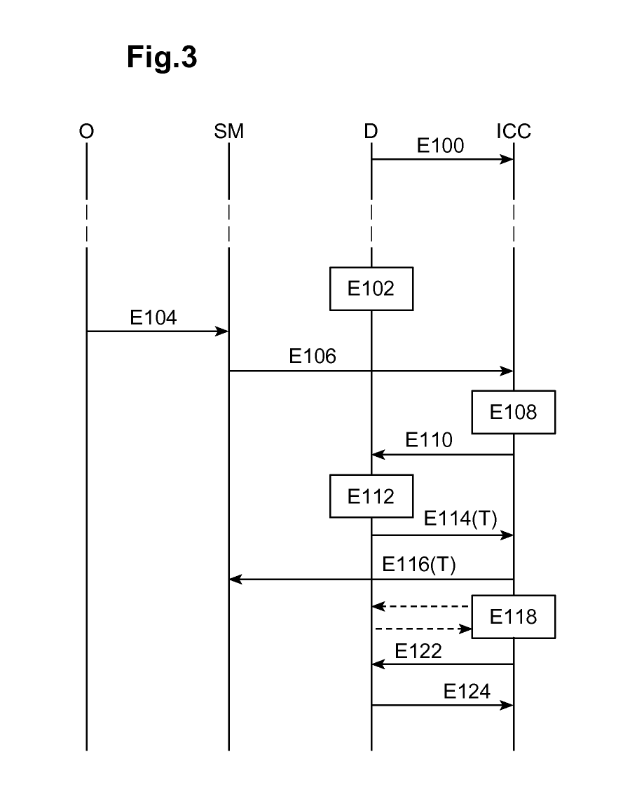

FIG. 3 shows a second example of a method for a profile change requested in an emergency situation, according to the teachings of the invention; and

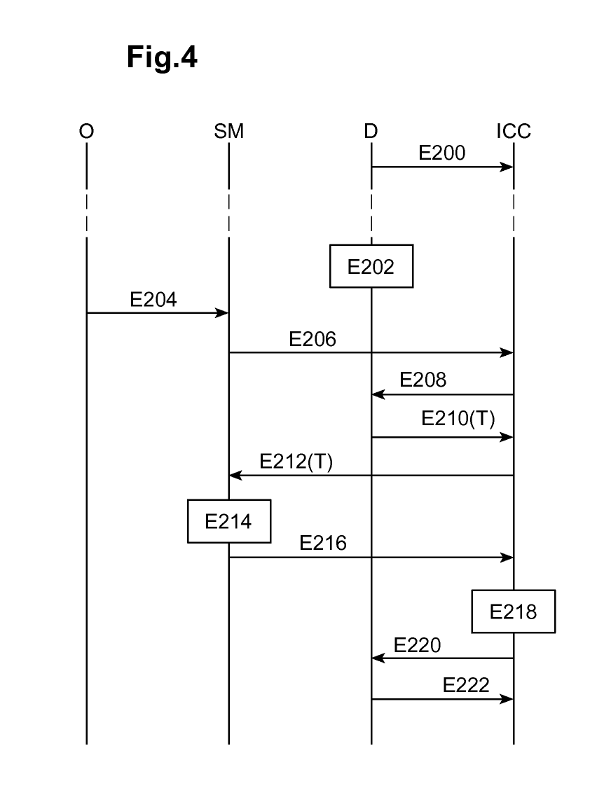

FIG. 4 shows a third example of a method for a profile change requested in an emergency situation, according to the teachings of the invention.

FIG. 1 shows schematically the main elements of a system in which the invention can be used.

This system comprises a device D, for example a vehicle provided with an emergency call system, which includes, notably, a microprocessor MP, an alert trigger A, a communication module COMM and a microcircuit card ICC. The microcircuit card ICC is connected to the communication module COMM (which thus acts as a reader of the microcircuit card ICC); the communication module COMM and the alert trigger A are, for example, each connected to the microprocessor MP, and can thus exchange data with this microprocessor MP. The microcircuit card ICC can exchange data with the microprocessor MP via the communication module COMM. The communication module is, for example, a stand-alone microcircuit present in a network interface which manages all the radio functions of the device D (such as data exchange on a local wireless network, or on a mobile telephone network as described below, etc.).

The microcircuit card ICC is, for example, integrated with the device D (being soldered thereto, in practice). In this case it is an eUICC (for “embedded Universal Integrated Circuit Card”) microcircuit card. In a variant, it would be possible to use another type of secure soldered component such as an eSE (for “embedded Secure Element”). In a variant, the secure element (which is an eUICC in the above example) could be a removable microcircuit card (or UICC, for “Universal Integrated Circuit Card”) or a secure integrated circuit (or SE, for “Secure Element”).

The microcircuit card ICC comprises a microcircuit MC which includes, notably, a microprocessor, a random access memory and a rewritable non-volatile memory, which enable the card to provide, notably, the functions of a platform manager G designed to manage (notably by activating or deactivating) profiles P1, P2 stored in the microcircuit card ICC.

The platform manager G and the profiles P1, P2 are, for example, contained in “security domains” (as they are known in English) such as those defined in the GlobalPlatform technical specifications, particularly the GlobalPlatform Card Specification 2.2; these security domains are associated with the subscription manager SM mentioned below.

It should be noted here that the profiles P1, P2 are installed on the microcircuit card (and then updated if necessary) by means of a dedicated profile manager (not shown), separate from the platform manager G.

Each profile P1, P2 comprises connection data on a telecommunication network N. The telecommunication network N is, for example, a mobile telephone network. The connection data of a profile P1, P2 are specific to the profile concerned; in other words, two separate profiles P1, P2 have separate connection data. These connection data include, notably, a subscriber number (of the MSISDN type, for example, for “Mobile Station ISDN Number”) and cryptographic keys that can be used to establish and/or to encipher communication via the telecommunication network N.

The telecommunication network N permits, for example, voice calls and/or data exchanges according to one or more of the following protocols: GSM, GPRS, EDGE, 3G, LTE, LTE-Advanced, 4G.

The example described here is within the context of mobile telephony; however, the invention is applicable in other contexts, for example wired communication or optical-fiber based networks.

The communication module COMM can establish communication on the telecommunication network N by using connection data of a profile P1, P2 present on the microcircuit card ICC.

The device D can thus enter into communication with another subscriber connected to the network N, for example an emergency call center EC. It should be noted that the situation described above can result in a call from the device D to the emergency call center EC (identified by a unique number, for example 112 for the European Union) or a call from the emergency call center EC to the device D (often a call back from the emergency call center EC after a first call or message transmitted from the device D to the emergency call center EC). Communication of this type uses, for example, a radio link between the device D and a base station BS of the telecommunication network N, then wired connections of the telecommunication network N between the base station BS and the emergency call center EC.

The device D is usually provided with an interface (for example a microphone and a loudspeaker, as well as a keypad and buttons corresponding to predefined instructions, if necessary), which enable a user of the device D to carry out exchanges with the personnel of the emergency call center EC by means of the previously established communication.

In FIG. 1, the reference O represents a central server of the network operator N and the reference SM shows a subscription manager.

These entities are described in the present description as separate entities, because of their different functional roles. However, it should be noted that they could be provided within a single physical entity (such as a server).

The subscription manager SM may enter into communication with the microcircuit card ICC, particularly with the platform manager G, for example by using an STK (for “SIM Application Toolkit”) protocol on the mobile telephony link provided by the telecommunication network N. A virtual channel V, secured if necessary, is then established between the platform manager G (provided on the microcircuit card ICC) and the subscription manager SM.

The alert trigger A is, for example, a push button depressed by the user of the device D in case of accident. In a variant, the trigger may be a sensor (such as an accelerometer) designed to transmit a signal when a strong deceleration is detected, indicating sudden braking and a probable accident. This sensor can also be used for triggering another safety system such as an inflatable safety cushion (or airbag, as it is usually called). Provision may also be made for a visual indicator (such as an indicator lamp or the display of a particular icon on a screen) to be activated in this case.

In all cases, when the alert trigger A transmits a signal to the microprocessor MP of the device D, the microprocessor MP commands the communication module COMM so that the device D connects to the telecommunication network N with the communication data of the active profile (for example the profile P1) and transmits an emergency call to the emergency call center EC. This emergency call allows the transmission of data (for example data on the geolocation of the device D) and/or a voice exchange between the personnel of the emergency call center EC and the user of the device D. It is, for example, an emergency call as provided by the initiative known as “eCall”. The aforementioned geolocation data are, for example, GPS (for “Global Positioning System”) coordinates, or data obtained by triangulation, using the cellular network.

In this situation it is desirable for the emergency call center EC to be able to re-contact the device D by using the telephone number assigned to the subscriber (the aforementioned subscriber number) according to the profile P1 (the profile used by the device D in the aforementioned initial call) throughout the assumed duration of the processing of the problem (the accident in this case), for example during a predetermined duration (possibly specified by regulatory texts); provision may be made for this predetermined duration to be between one hour and one day. In the example described here, the predetermined duration is equal to one hour.

FIG. 2 shows a first example of a method for a profile change requested in an emergency situation of this kind, according to the teachings of the invention. As will be apparent from the following description, this method is adapted to recognize the presence of an emergency situation initiated by the transmission of an emergency call as described above.

It is therefore proposed that the terminal profile characterizing the device D include information indicating that the device D is designed to transmit an emergency call (this information being represented, for example, by a bit of the 32nd byte of the terminal profile defined in the ETSI TS 102 223 technical specification, such as bit b1 of this octet). This terminal profile is transmitted from the device D to the microcircuit card ICC in a step E0, executed for example when the device D is switched on.

The situation in which the alert trigger A causes the transmission of an emergency call by the communication module COMM (step E2) by using the profile P1, as indicated above, will now be considered. As explained, it is desirable for the device D to be contactable by the emergency call center EC for a predetermined duration (corresponding to the emergency situation processing time) and by using the subscriber number of the device D (associated with the profile P1) received by the emergency call center EC during the emergency call of step E2.

We are concerned here with the case in which the activation of a new profile P2 is then requested by the operator, by the transmission of a profile activation message by the server of the operator O to the subscription manager SM (step E4).

On receipt of this message, the subscription manager SM transmits a profile activation command (step E6) to the microcircuit card ICC, or more precisely to the platform manager G (here in the form of the STK command as indicated above). This step includes, for example, a process of mutual authentication between the platform manager G and the subscription manager SM.

On receipt of this profile activation command, the microcircuit card ICC prepares for the change of profile in a step E8. This step includes, for example, the downloading of certain data, at least, on the new profile.

However, the profile change is not effective until the card has been reinitialized (that is to say, in this case, switched off and then switched on again). If necessary, it is possible to use a flag, stored for example in the rewritable non-volatile memory of the microcircuit card ICC, which indicates that the profile change has been prepared (that is to say, that step E8 has been executed), but is not effective.

The microcircuit card ICC then sends to the device D a request for the updating of the information on the microcircuit card ICC used by the device (step E10), for example a “REFRESH” command as defined in the ETSI TS 102 223 technical specification, in this case in reinitialization mode, that is to say representing a request for reinitialization of the microcircuit card ICC by the device D.

The device D receives the request for updating with reinitialization of the microcircuit card ICC. If there were no current emergency situation, the device D would command the reinitialization of the microcircuit card ICC.

However, in the case shown in FIG. 2, it is assumed that the processing of the emergency situation is in progress; that is to say, the time elapsed since the transmission of the emergency call in step E2 is less than the predetermined duration of the processing of the emergency situation, a fact which the device D is able to determine in step E12.

The device D then sends to the microcircuit card ICC a request rejection message, indicative of the state of processing of the emergency situation (step E14), and does not proceed with the reinitialization of the microcircuit card ICC as requested by the message in step E10. Provision is made here for this message indicative of the state of processing to further include a data element representative of the remaining time T for the processing of the emergency situation, that is to say representative of the difference between the predetermined duration of the emergency situation and the time already elapsed since the transmission of the emergency call (a difference determined by the device D).

The microcircuit card ICC then sends a notification indicative of the state of processing of the emergency situation to the subscription manager SM (step E16), accompanied if necessary in the aforementioned case by the remaining time T for the processing of the emergency situation.

The subscription manager SM then triggers a counter (step E18), in this case with a duration equal to the remaining time T received in the notification of step E16. In a variant, notably if no information on the remaining time T has been communicated with the notification of step E16, the counter duration could be initialized to a predetermined duration (for example one hour, corresponding, in the system described here, to the maximum duration during which the emergency situation may be in progress).

On the expiry of the counter set by the subscription manager SM, the subscription manager SM transmits to the microcircuit card ICC (or more precisely to the platform manager G implemented in the microcircuit card ICC) a command for a new profile activation attempt (step E20), for example a command of the RETRY type. This new attempt command has, for example, an effect identical to the profile activation command of step E6, but without including any authentication process.

In a variant, the subscription manager SM could transmit a new profile activation command in step E20, identical to that of step E6.

On receipt of the new attempt command (or the new activation command), the microcircuit card ICC consults the flag which indicates that the profile change has been prepared but is not effective. The microcircuit card ICC therefore attempts once more to make the profile change effective, by sending again in step E22 a request to update the information on the microcircuit card ICC used by the device, in reinitialization mode (the “REFRESH” command), which corresponds, as indicated above, to a request for the reinitialization of the microcircuit card ICC by the device D.

Since the emergency situation is then terminated (because of the use of the counter in step E18), the device D executes the request for reinitialization of the microcircuit card ICC, by interrupting the power supply to the microcircuit card ICC, and then restoring this power supply and executing a start-up process on the microcircuit card ICC (step E24).

This start-up process includes, notably, the activation of the new profile P2 in the microcircuit card ICC and the communication of the terminal profile to the microcircuit card ICC (as described above for step E0). FIG. 3 shows a second example of a method for a profile change requested in an emergency situation.

In a preliminary step E100, the terminal profile is transmitted from the device D to the microcircuit card. This terminal profile includes, for example, information indicating that the device D is designed to transmit an emergency call.

In step E102, the alert trigger A causes the transmission of an emergency call by the communication module COMM, using the currently activated profile (P1 in this case): the emergency call is transmitted over the telecommunication network N, using the connection data associated with the currently activated profile P1.

As in the first embodiment described with reference to FIG. 2, we are concerned with the case in which the activation of a new profile P2 is then requested by the operator, by the transmission, in step E104, of a profile activation message from the server of the operator O to the subscription manager SM.

On receipt of this message, the subscription manager SM transmits a profile activation command (step E106) to the platform manager G implemented by the microcircuit card ICC. This step includes, for example, a process of mutual authentication between the platform manager G and the subscription manager SM.

On receipt of this profile activation command, the microcircuit card ICC prepares for the change of profile in a step E108.

As before, however, the profile change is not effective until the card has been reinitialized; it is possible to provide for a flag, stored for example in the rewritable non-volatile memory of the microcircuit card ICC, to indicate that the profile change has been prepared (that is to say, that step E8 has been executed), but is not effective.

In step E110, the microcircuit card ICC then sends to the device D a request for the updating of the information on the microcircuit card ICC used by the device. As in the first embodiment, this request is, for example, a “REFRESH” command in reinitialization mode, that is to say a command representing a request for the reinitialization of the microcircuit card ICC by the device D.

The device D receives the request for updating with reinitialization of the microcircuit card ICC.

If the emergency situation is in progress at the moment when the device D receives the updating request, that is to say if the device D determines in step E112 that the time elapsed since the transmission of the emergency call in step E102 is less than the predetermined duration of processing of the emergency situation, the device D sends to the microcircuit card ICC a request rejection message, indicative of the state of processing of the emergency situation (step E114), and does not proceed with the reinitialization of the microcircuit card ICC as requested by the message in step E110.

As mentioned above for the first embodiment, provision may be made here for this message indicative of the state of processing to further include a data element representative of the remaining time T for the processing of the emergency situation, that is to say representative of the difference between the predetermined duration of the emergency situation and the time already elapsed since the transmission of the emergency call (a difference determined by the device D).

According to a feasible embodiment, the microcircuit card ICC may then send a notification indicative of the state of processing of the emergency situation to the subscription manager SM (step E116), accompanied if necessary in the aforementioned case by the remaining time T for the processing of the emergency situation. The microcircuit card ICC then also triggers a counter (step E118), in this case with a duration equal to the remaining time T received in the rejection message of step E114. In a variant, notably if no information on the remaining time T has been communicated with the message of step E114, the counter duration could be initialized to a predetermined duration (for example one hour, corresponding to the maximum duration during which the emergency situation may be in progress).

The counter triggered by the microcircuit card ICC may be physically located outside the microcircuit card ICC: the counter is, for example, located within the device D, or more precisely within the microprocessor MP or the communication module COMM, as is the case if the microcircuit card ICC uses the TIMER MANAGEMENT command described in the ETSI TS 102 223 technical specification. In a variant, it is possible, for example, to use the STATUS command defined in the same technical specification so that the card receives a wake-up instruction periodically (with a specified period), enabling the microcircuit card ICC to measure the passage of time.

On the expiry of the counter triggered by the microcircuit card ICC (that is to say, for example, on receipt of a message from the device D signifying the expiry of the counter triggered in step E118), the microcircuit card ICC consults the flag which indicates that the profile change has been prepared but is not effective. The microcircuit card ICC therefore attempts once more to make the profile change effective, by sending again in step E122 a request to update the information on the microcircuit card ICC used by the device (the “REFRESH” command) in reinitialization mode, which corresponds, as indicated above, to a request for the reinitialization of the microcircuit card ICC by the device D.

Since the emergency situation is then terminated (because of the use of the counter in step E118), the device D executes the request for reinitialization of the microcircuit card ICC, by interrupting the power supply to the microcircuit card ICC, and then restoring this power supply and executing a start-up process on the microcircuit card ICC (step E124).

This start-up process includes, notably, the activation of the new profile P2 in the microcircuit card ICC and the communication of the terminal profile to the microcircuit card ICC (as described above for step E100).

FIG. 4 shows a third example of a method for a profile change requested in an emergency situation.

In a preliminary step E200, a terminal profile, including, notably, information indicating that the device D is designed to transmit an emergency call, is transmitted from the device D to the microcircuit card ICC.

In step E202, the alert trigger A causes the transmission of an emergency call by the communication module COMM, using the currently activated profile (P1 in this case).

As in the embodiments described above, we are concerned with the case in which the activation of a new profile P2 is then requested by the operator, by the transmission of a profile activation message by the server of the operator 0 to the subscription manager SM (step E204).

On receipt of this message, the subscription manager SM transmits a profile activation command (step E206) to the platform manager G implemented by the microcircuit card ICC. This step includes, for example, a process of mutual authentication between the platform manager G and the subscription manager SM.

On receipt of this profile activation command, the microcircuit card ICC consults the terminal profile (received in step E200) to determine whether the device D is designed to transmit an emergency call. If this is the case (as in the example described here), the microcircuit card ICC then sends, in step E208, a proactive command to the device D to interrogate the device D as to the presence of an emergency situation in progress. This command is, for example, a new type of dedicated command, which also conforms to the STK format.

The device D then sends, in step E210, a response indicating whether or not an emergency situation is in progress, and further comprising, if required, data representative of the time interval T remaining before the end of the emergency situation. As mentioned above, this remaining time T may be calculated by the device D by finding the difference between the current time (the time of receipt of the proactive command of step E208) and the time of transmission of the emergency call (step E202). Provision may be made, for example, for the response to consist solely of the data element representative of the remaining time T, expressed in minutes according to a feasible embodiment, a data element representing a zero value signifying that there is no emergency situation in progress.

It should be noted that, if the terminal profile indicates that the device D is not designed to transmit an emergency call, or if the response received in step E210 indicates that no emergency situation is in progress, it is possible to proceed directly to step E218 in which the preparation for the profile change takes place as described below.

If the response received in step E210 indicates that an emergency situation is in progress, the microcircuit card ICC sends a notification indicative of the state of the emergency situation to the subscription manager SM (step E212), accompanied if necessary, in the aforementioned case, by the remaining time T for the processing of the emergency situation.

The subscription manager SM then triggers a counter (step E214), in this case with a duration equal to the remaining time T received in the notification of step E212. In a variant, notably if no information on the remaining time T has been communicated with the notification of step E212, the counter duration could be initialized to a predetermined duration (for example one hour, corresponding, in the system described here, to the maximum duration for which the emergency situation may be in progress).

On the expiry of the counter set by the subscription manager SM, the subscription manager SM transmits to the microcircuit card ICC (or more precisely to the platform manager G implemented in the microcircuit card ICC) a command for a new profile activation attempt (step E216). This new attempt command has, for example, an effect identical to the profile activation command of step E206, but without including any authentication process.

On receipt of this command for a new profile activation attempt, the microcircuit card ICC prepares for the change of profile in a step E218. Provision may be made for the microcircuit card ICC to check, before preparing the profile change, that no emergency situation is in progress, for example according to the process described above (steps E208 and E210).

However, the profile change is not effective until the card has been reinitialized.

The microcircuit card ICC then sends to the device D a request for the updating of the information on the microcircuit card ICC used by the device (step E220), for example a “REFRESH” command, in this case in reinitialization mode, that is to say representing a request for reinitialization of the microcircuit card ICC by the device D.

The device D receives the request for updating with reinitialization of the microcircuit card ICC and executes this request for reinitialization of the microcircuit card ICC, by interrupting the power supply to the microcircuit card ICC, and then restoring this power supply and executing a start-up process on the microcircuit card ICC (step E222).

This start-up process includes, notably, the activation of the new profile P2 in the microcircuit card ICC and the communication of the terminal profile to the microcircuit card ICC (as described above for step E200).

In the embodiment that has just been described, a counter triggered by the subscription manager SM on receipt of the notification of step E212 is used, as in the first embodiment described above with reference to FIG. 2. According to a feasible variant, a counter triggered by the microcircuit card ICC could be used, as in the second embodiment described above with reference to FIG. 3, in this case when the response of step E210 is received; in this case, the step of preparing for the profile change is executed on the expiry of the counter triggered by the microcircuit card.

1. A profile modification method in a device comprising a communication module for communicating on a communication network, the device being provided with a microcircuit storing connection data used by the communication module and associated with a profile, said method comprising the following steps:
reception, by the microcircuit and via the communication module, of a request to deactivate the profile;
transmission by the microcircuit of a first message to the device;
transmission, by the device to the microcircuit, of a response indicative of presence of a critical situation;
following receipt of said response by the microcircuit, implementation of a time delay mechanism;
on expiry of the time delay, transmission, by the microcircuit to the device, of a second message causing deactivation of the profile.

2. The profile modification method as claimed in claim 1, wherein the response indicative of the presence of the critical situation contains a data element representative of a remaining duration of the critical situation.

3. The profile modification method as claimed in claim 1, wherein the first message is a proactive command resulting in interrogation about the presence of the critical situation.

4. The profile modification method as claimed in claim 3, wherein a step of preparing the profile modification is executed by the microcircuit after expiry of the time delay.

5. The profile modification method as claimed in claim 1, wherein the first message is a request for updating the information on the microcircuit used by the device.

6. The profile modification method as claimed in claim 5, wherein a step of preparing the profile modification is executed by the microcircuit on receipt of the request for deactivation of the profile.

7. The profile modification method as claimed in claim 5, wherein the response indicative of the presence of the critical situation is a message rejecting the updating request.

8. The profile modification method as claimed in claim 1, comprising a step of transmission, by the microcircuit to an operating server of the communication network, of a message of notification of the critical situation.

9. The profile modification method as claimed in claim 8, wherein the response indicative of the presence of the critical situation contains a data element representative of a remaining duration of the critical situation, and wherein the notification message comprises a data element representative of said remaining duration.

10. The profile modification method as claimed in claim 8, wherein the time delay mechanism is a counter triggered by the operating server of the communication network on receipt of the notification message.

11. The profile modification method as claimed in claim 10, wherein the response indicative of the presence of the critical situation contains a data element representative of a remaining duration of the critical situation, wherein the notification message includes a data element representative of said remaining duration, and wherein the counter is initialized to the value represented by the data element included in the notification message.

12. The profile modification method as claimed in claim 10, wherein, on expiry of the counter, a message for deactivation of the profile is transmitted from the operating server of the communication network to the microcircuit.

13. The profile modification method as claimed in claim 1, wherein the time delay mechanism is a counter triggered by the microcircuit on receipt of the response indicative of the presence of the critical situation.

14. The profile modification method as claimed in claim 13, wherein the response indicative of the presence of the critical situation includes a data element representative of a remaining duration of the critical situation, and wherein the counter is initialized to the value represented by the data element included in the response indicative of the presence of the critical situation.

15. The profile modification method as claimed in claim 1, comprising a preliminary step of transmission of an emergency call by the communication module, using the connection data associated with the profile.

16. A device comprising a communication module for communicating on a communication network, the device being provided with a microcircuit storing connection data used by the communication module and associated with a profile, said device comprising:
means for reception, by the microcircuit and via the communication module, of a request to deactivate the profile;
means for transmission by the microcircuit of a first message to the device;
means for transmission, by the device to the microcircuit, of a response indicative of presence of a critical situation;
means designed to implement, following receipt of said response by the microcircuit, a time delay mechanism;
means for transmission, by the microcircuit to the device, on expiry of the time delay, of a second message causing deactivation of the profile.

17. A microcircuit intended to be provided in a device comprising a communication module for communicating on a communication network, the microcircuit storing connection data used by the communication module and associated with a profile, the microcircuit comprising:
means for reception, via the communication module, of a request to deactivate the profile;
means for transmission of a first message to the device;
means for reception of a response indicative of presence of a critical situation;
means designed to implement, following receipt of said response, a time delay mechanism;
means for transmission to the device, on expiry of the time delay, of a second message causing deactivation of the profile.
